(19) United States
(12) Patent Application Publication
(10) Pub. No.: US 2016/0346768 A1
(43) Pub. Date: Dec. 1, 2016

(54) PROCESS FOR PREPARING A MULTIELEMENT OXIDE COMPRISING BISMUTH AND TUNGSTEN BY COPRECIPITATION

(71) Applicant: BASF SE, Ludwigshafen am Rhein (DE)

(72) Inventors: Stefan Wrobel, Steinheim (DE); Wolfgang Hellerich, Loechgau (DE); Cathrin Alexandra Welker-Nieuwoudt, Birkenheide (DE); Cornelia Katharina Dobner, Neustadt (DE)

(73) Assignee: BASF SE, Ludwigshafen am Rhein (DE)

(21) Appl. No.: 15/164,097

(22) Filed: May 25, 2016

Related U.S. Application Data
(60) Provisional application No. 62/166,692, filed on May 27, 2015.

(30) Foreign Application Priority Data
May 27, 2015 (DE) 10 2015 209 638.6

(51) Int. Cl. B01J 23/888; B01J 35/02; B01J 37/00; B01J 37/08; B01J 23/31; B01J 37/03

(52) U.S. Cl. CPC B01J 23/8885; B01J 23/31; B01J 37/031; B01J 37/009; B01J 37/08; B01J 35/02

(57) ABSTRACT

Shaped catalyst bodies comprising a multielement oxide I having the general stoichiometry I [Bi₁W_{b}Oₓ]ₐ[Mo₁₂Z¹_{c}Z²_{d}FeₑZ³_{f}Z⁴_{g}Z⁵ₕO_{y}]₁ (I), where Z¹=Ni or Co, Z²=alkali metal or alkaline earth metal, Z³=zinc, phosphorus, arsenic, boron, antimony, tin, cerium, vanadium, chromium or bismuth, Z⁴=silicon, aluminum, titanium, tungsten or zirconiurn, Z⁵=copper, silver, gold, yttrium, lanthanum and lanthanides, a=0.1 to 3, b=0.1 to 10, c=1 to 10, d=0.01 to 2, e=0.01 to 5, f=0 to 5, g=0 to 10, h=0 to 1 and x, y=numbers determined by the valence and abundance of the elements other than oxygen in I, as active composition are produced by preforming a mixed oxide Bi₁W_{b}Oₓ by coprecipitation from an aqueous environment at a pH in the range from 1.5 to 3 and isolation of the precipitate by means of a mechanical separation process and mixing the preformed mixed oxide Bi₁W_{b}Oₓ with a precursor having the stoichiometry [Mo₁₂Z¹_{c}Z²_{d}FeₑZ³_{f}Z⁴_{g}Z⁵ₕO_{y}], shaping the mixture to form shaped bodies and thermally treating and calcining the shaped bodies at elevated temperature to give the shaped catalyst bodies. The process leads to homogeneous precipitation products having a stoichiometric composition. It is an alternative to the energy-intensive production by spray drying.

The present invention relates to a process for producing shaped catalyst bodies comprising a multielement oxide comprising bismuth and tungsten as active composition.

Multielement oxides which comprise bismuth and tungsten together with other elements such as molybdenum and iron are employed as catalysts for the gas-phase oxidation of alkenes to unsaturated aldehydes, in particular the gas-phase oxidation of propene to acrolein. In a further step, acrolein is oxidized to acrylic acid which is an important starting material for the chemical industry.

It is known that the properties of the multielement oxide catalysts are greatly improved when a bismuth-tungsten oxide key phase is preformed separately and then mixed with sources of the other constituents of the multimetal oxide and processed to give the catalyst.

U.S. Pat. No. 4,537,874 discloses a process in which aqueous bismuth nitrate solution is admixed with ammonia and the resulting precipitate is filtered off and washed. The precipitate is mixed with tungsten trioxide, dried and calcined. The bismuth-tungsten oxide obtained in this way is mixed with a pulverulent mixture of further constituents, shaped to form pellets and calcined.

DE 10 2008 042 064 A1 describes a process for producing shaped catalyst bodies, in which a finely divided oxide Bi₁W_{b}Oₓ and a finely divided intimate mixture having the stoichiometry Mo₁₂Z¹_{c}Z²_{d}FeₑZ³_{f}Z⁴_{g}Z⁵ₕ are formed from element sources and mixed. To prepare the oxide Bi₁W_{b}Oₓ, tungstic acid is stirred a little at a time into aqueous bismuth nitrate solution and the resulting aqueous mixture is spray dried, the powder is extruded and calcined.

WO 2007/042369 describes a process for producing mixed oxide catalysts, in which solutions of compounds of the metals comprised in the mixed oxide catalysts are mixed, coprecipitates are produced, the solid obtained is isolated, dried, calcined and optionally shaped. The mixed oxide catalysts are employed for preparing aldehydes and acids by oxidation of olefins or methylated aromatics by means of air or oxygen.

Spray drying is a preferred process for producing the bismuth-tungsten oxide precursor since the homogeneous distribution of bismuth and tungsten in the aqueous mixture is fixed by the sudden withdrawal of water. During calcination, it is then possible to obtain a phase which has the desired stoichiometry and is largely free of foreign phases. The phases WO₃ (monoclinic) and Bi₂W₂O₉ (orthorhombic) are desirable, but the presence of γ-Bi₂WO₆ (russelite) is undesirable. It is assumed that the activity and selectivity of the catalyst are related to the presence of corner-linked W—O octahedra in the volume of the solid, which make tetragonal-pyramidal W—O sites at the surface possible.

Spray drying is an energy-intensive process which additionally requires a specific spray-drying plant. It is therefore desirable to have alternative production routes available. The preparation of multielement oxide compositions by coprecipitation is known in principle; here, mixed solutions of water-soluble compounds of the elemental constituents are admixed with alkali and a precipitate of a mixed hydroxide and/or oxide is obtained.

However, there are potential concerns associated with the preparation of bismuth-tungsten oxide by coprecipitation. Bismuth oxide is an amphoteric oxide. The precipitation can lead to inhomogeneous precipitation products with, for example, phases having a superstoichiometric tungsten content being able to be formed in addition to phases which have a lower tungsten content or pure bismuth oxide. In addition, bismuth oxide and tungsten oxide tend to be obtained in a form which is finely divided and/or difficult to filter. It is an object of the invention to provide a process which avoids the above-described problems.

The invention provides a process for producing shaped catalyst bodies comprising a multielement oxide of the general stoichiometry I as active composition,

[Bi₁W_{b}Oₓ]ₐ[Mo₁₂Z¹_{c}Z²_{d}FeₑZ³_{f}Z⁴_{g}Z⁵ₕO_{y}]₁ (I)

where

Z¹=an element or more than one element from the group consisting of nickel and cobalt,

Z²=an element or more than one element from the group consisting of the alkali metals and the alkaline earth metals,

Z³=an element or more than one element from the group consisting of zinc, phosphorus, arsenic, boron, antimony, tin, cerium, vanadium, chromium and bismuth,

Z⁴=an element or more than one element from the group consisting of silicon, aluminum, titanium, tungsten and zirconium,

Z⁵=an element or more than one element from the group consisting of copper, silver, gold, yttrium, lanthanum and the lanthanides,

a=0.1 to 3,

b=0.1 to 10,

c=1 to 10,

d=0.01 to 2,

e=0.01 to 5,

f=0 to 5,

g=0 to 10,

h=0 to 1, and

x, y=numbers which are determined by the valence and abundance of the elements other than oxygen in I,

wherein a mixed oxide Bi₁W_{b}Oₓ is preformed and the preformation of the mixed oxide Bi₁W_{b}Oₓ comprises coprecipitation from an aqueous environment at a pH in the range from 1.5 to 3, preferably from 1.5 to 2.5, in particular about 2, and isolation of the precipitate by means of a mechanical separation process.

Z¹ is preferably exclusively Co in the process of the invention.

Z² is preferably K, Cs and/or Sr, particularly preferably K, in the process of the invention.

Z⁴ is preferably Si in the process of the invention.

The stoichiometric coefficient a is advantageously from 1.0 to 2.0.

The stoichiometric coefficient b is advantageously from 0.5 to 4 or up to 3, particularly advantageously from 1 to 2.5 and very particularly advantageously from 1.5 to 2.5.

The stoichiometric coefficient c is preferably from 3 to 8, particularly advantageously from 4 to 7 and very particularly advantageously from 5 to 6.

The stoichiometric coefficient d is advantageously from 0.02 to 2 and particularly advantageously from 0.03 to 1 or from 0.05 to 0.5.

The stoichiometric coefficient e is advantageously from 0.1 to 4.5, preferably from 0.5 to 4 and particularly preferably from 1 to 4 or from 2 to 4.

The stoichiometric coefficient g is preferably from >0 to 10, particularly preferably from 0.1 to 8 or from 0.2 to 7, very particularly preferably from 0.3 to 6 or from 0.4 to 5, and most advantageously from 0.5 to 3 or from 1 to 3.

The stoichiometric coefficients h and f can both simultaneously be 0, but can also assume, independently of one another, values different from 0. The moiety [Mo₁₂Z¹_{c}Z²_{d}FeₑZ³_{f}Z⁴_{g}Z⁵ₕO_{y}] preferably does not comprise any Bi.

In general, at least one source of the element Bi and at least one source of the element W (i.e. at least one starting compound comprising the element Bi and at least one starting compound comprising the element W) will be intimately mixed with one another in an aqueous medium and brought to a pH in the range from 1.5 to 3, preferably from 1.5 to 2.5, in particular about 2.

It has been found to be preferable for large pH gradients to be avoided during mixing of the source of the element Bi and the source of the element W. For this reason, preference is given to initially charging an aqueous preparation of a bismuth source having a pH of from 1.5 to 3, preferably from 1.5 to 2.5, in particular about 2, adding an aqueous preparation of a tungsten source and maintaining the pH of the mixture in the range from 1.5 to 3, preferably from 1.5 to 2.5, in particular about 2, during the addition of the tungsten source.

Possible sources of Bi and W are in principle compounds which are already oxides of these elements or compounds which can be converted by heating, at least in the presence of molecular oxygen, into oxides. Preference is given to using water-soluble salts of bismuth such as nitrates, carbonates, hydroxides and/or acetates as bismuth source. Tungstic acid and/or tungsten oxide are preferably used as tungsten source. Tungstic acid, which is essentially insoluble in water, is preferably used as finely divided powder whose d₉₀ is technologically advantageously ≦5 μm or 2 μm, preferably from 0.1 to 1 μm. Tungstic acid is appropriately added in the form of an aqueous slurry. Sodium tungstate is a further tungsten source.

It is not absolutely necessary for the sources of Bi and W to be present in completely dissolved form. It is also possible to use aqueous slurries of the sources of Bi and/or W as starting materials. In this case, coprecipitation occurs with intermediate dissolution of the incompletely dissolved source of Bi and/or W.

The setting of the pH in the range indicated is effected by addition of suitable amounts of an acid or base, preferably in the form of an aqueous solution.

When tungstic acid and/or tungsten oxide is used as tungsten source, the pH of the mixture is maintained in the range from 1.5 to 3, preferably from 1.5 to 2.5, in particular about 2, by addition of a base during the addition of the tungsten source.

Suitable bases are alkali metal hydroxide such as sodium hydroxide or potassium hydroxide, or alkali metal (hydrogen)carbonates such as sodium carbonate. Aqueous sodium hydroxide solutions having a concentration of from 5 to 40% by weight, preferably from 12 to 25% by weight, are particularly suitable.

The use of ammonia as base is less preferred. The coprecipitation is preferably carried out in the absence of ammonia and ammonium ions.

The addition of the tungsten source and the addition of the base are carried out with appropriate mixing, e.g. with stirring.

The coprecipitation is generally carried out at a temperature of from 10° C. to 90° C., preferably at room temperature. The pressure is not critical and is preferably ambient pressure. Although not preferred, hydrothermal conditions can also be employed. The addition of the aqueous preparation of a tungsten source to an initially charged preparation of a bismuth source is preferably carried out over a period of time, e.g. over a time of from 1 to 40 minutes, in particular from 10 to 30 minutes. After the addition is complete, the suspension obtained is preferably stirred further, e.g. for a time of from 1 to 5 hours, in particular from 2 to 4 hours.

A characteristic of the process of the invention is that the isolation of the precipitate is effected by means of a mechanical separation process. The mechanical separation process is, for example, selected from among filtration, centrifugation, sedimentation and floatation. Filtration is a particularly preferred mechanical separation process. Suitable filter elements comprise, for example, nonwovens, felts or sintered plates. Furthermore, filter cloths which are placed in filtration apparatuses such as filter presses or centrifuges are suitable.

These filter cloths for chamber filter presses have two filter cloth halves to be arranged in parallel. They are placed on the individual filter plates of the filter presses in such a way that the two filter cloth halves cover opposite areas of the filter plates. A plurality of such filter plates covered with filter cloths are then pressed together. The suspension to be filtered is pumped into the hollow space between the cloths and flows into the drainage space behind the cloths, leaving behind the filter cake, and from there flows to the outside.

In general, the precipitate is washed salt-free by means of a suitable washing liquid. The washing liquid is generally deionized water, Washing can be effected by slurrying in the washing liquid and decantation. The slurrying in the washing liquid and decantation can preferably be repeated one or more times. As an alternative, washing can be effected by the washing liquid flowing through a filter cake of the precipitate. The success of washing can be monitored by measuring the conductivity of the used washing liquid. The precipitate is considered to be salt-free when deionized water (pH 7.0) which has been equilibrated with the washed precipitate (e.g. 1 l of water per 500 g of precipitate, calculated as dry mass of oxide) has a conductivity at 25° C. of less than 800 μS.

The precipitate is then dried in a conventional way, e.g. in a drying oven, tray oven, rotary tube dryer or the like.

The resulting dry composition is calcined (thermally treated) at temperatures in the range from 400 to 900° C. (preferably from 600 to 900° C. and particularly preferably from 700 to 900° C.). The thermal treatment is usually carried out in a stream of air (e.g. in a rotary tube furnace as is described in DE-A 103 25 487).

The resulting calcined material is comminuted to give a finely divided starting composition. The particle diameter d₅₀ is preferably from 2.9 to 3.6 μm (unless indicated otherwise, the particle sizes indicated are the values determined by laser light scattering in aqueous suspension without prior ultrasonic treatment). The breaking up of the calcined mixed oxide to a desired particle diameter is normally brought about by milling in mills. If required, the milled material is subsequently classified to the desired degree of comminution.

The isolated precipitate can optionally advantageously be coarsened before calcination by, for example, technologically advantageously being made up into a paste with addition of up to 20% by weight of water and, for example, being extruded by means of an extruder to give extrudates which are simpler to handle for calcination purposes; these are subsequently dried and then calcined.

Previously formed mixed oxides Bi₁W_{b}Oₓ which are preferred for the purposes of the process of the invention are the mixed oxides Bi₁W_{2.5}O₉ (½Bi₂W₂O₉.1.5WO₃), Bi₁W₃O_{10.5} (½Bi₂W₂O₉.2WO₃), Bi₁W₄O_{13.5} (½Bi₂W₂O₉.3WO₃), Bi₁W_{0.5}O₃, Bi₁W₁O_{4.5} (½Bi₂W₂O₉), Bi₁W₂O_{7.5} (½Bi₂W₂O₉.1WO₃) and Bi₁W_{1.5}O₆ (½Bi₂W₂O₉.½WO₃), among which Bi₁W₂O_{7.5} is very particularly preferred according to the invention.

Substances which are broken down and/or decomposed (chemically reacted) to form compounds which are given off in gaseous form under the conditions of the thermal treatment employed for forming the mixed oxide Bi₁W_{b}Oₓ can additionally be incorporated into the aqueous mixture of the at least one Bi source and the at least one W source during the preparation of the mixed oxide Bi₁W_{b}Oₓ. Such substances can, for example, function as pore formers and be included in order to influence the active internal surface area of the mixed oxide Bi₁W_{b}Oₓ.

Possible (auxiliary) substances of this type are, for example, NH₄OH, (NH₄)₂CO₃, NH₄HCO₃, NH₄NO₃, urea, NH₄CHO₂, H₂CO₃, HNO₃, H₂SO₄, NH₄CH₃CO₂, NH₄HSO₄, NH₄Cl, HCl, (NH₄)₂SO₄, ammonium oxalate, hydrates of the abovementioned compounds and also organic substances such as stearic acid, malonic acid, ammonium salts of the abovementioned acids, starches (e.g. potato starch and maize starch), cellulose, ground nut shells, finely divided polymer flour (e.g. polyethylene, polypropylene), etc.

The preformed mixed oxide Bi₁W_{b}Oₓ is then mixed with element sources having the stoichiometry [Mo₁₂Z¹_{c}Z²_{d}FeₑZ³_{f}Z⁴_{g}Z⁵ₕO_{y}], the mixture is shaped to form shaped bodies and the shaped bodies are thermally treated and calcined at elevated temperature to give the shaped catalyst bodies. Mixing can be carried out dry or wet.

However, preference is given to mixing the preformed mixed oxide Bi₁W_{b}Oₓ with a previously formed pulverulent precursor having the stoichiometry [Mo₁₂Z¹_{c}Z²_{d}FeₑZ³_{f}Z⁴_{g}Z⁵ₕO_{y}]. For the purposes of the present invention, a precursor having the stoichiometry [Mo₁₂Z¹_{c}Z²_{d}FeₑZ³_{f}Z⁴_{g}Z⁵ₕO_{y}] is a mixture of element sources in suitable relative amounts which on calcination, at least in the presence of molecular oxygen, gives a multielement oxide having the stoichiometry [Mo₁₂Z¹_{c}Z²_{d}FeₑZ³_{f}Z⁴_{g}Z⁵ₕO_{y}].

Possible sources for the elements of the moiety [Mo₁₂Z¹_{c}Z²_{d}FeₑZ³_{f}Z⁴_{g}Z⁵ₕO_{y}] of the desired multi element oxide active composition of the invention are in principle compounds which are already oxides and/or compounds which can be converted by heating, at least in the presence of molecular oxygen, into oxides.

Apart from the oxides, suitable starting compounds (sources) of this type are, in particular, halides, nitrates, formates, oxalates, citrates, acetates, carbonates, amine complexes, ammonium salts and/or hydroxides (and also hydrates of the abovementioned salts).

An advantageous Mo source is ammonium heptamolybdate tetrahydrate. However, it is in principle also possible to use, for example, molybdenum trioxide. Z¹ sources which are favorable for the purposes of the invention are the nitrates or nitrate hydrates of the Z¹ elements. Z² sources which are advantageous for the purposes of the invention are the hydroxides and nitrates of the Z² elements and hydrates thereof. In the case of the element iron, an iron nitrate hydrate is advantageously used in the process of the invention.

Silica sol forms the Si source which is preferred according to the invention. Lanthanides which are preferred according to the invention are Er, Tb, Ho, Eu, Tm, Nd, Lu, Dy, Gd, Ce and Sm. As source of these, preference is given, as in the case of La and Y, to using the corresponding nitrate hydrates.

Apart from the relevant sources of the elements of the moiety [Mo₁₂Z¹_{c}Z²_{d}FeₑZ³_{f}Z⁴_{g}Z⁵ₕO_{y}] of the multielement oxide I, substances which are broken down and/or decomposed (chemically reacted) to form compounds which are given off in gaseous form at least under the conditions of the thermal treatment of the geometric shaped bodies to form the geometric shaped catalyst bodies can be additionally incorporated into the respective aqueous mixture. Such substances can, for example, function as pore formers and be included in order to set the active internal surface area. Suitable (auxiliary) substances of this type are, for example, NH₄OH, (NH₄)₂CO₃, NH₄HCO₃, NH₄NO₃, urea, NH₄CHO₂, H₂CO₃, HNO₃, H₂SO₄, NH₄CH₃CO₂, NH₄HSO₄, NH₄Cl, HCl, (NH₄)₂SO₄, ammonium oxalate, hydrates of the abovementioned compounds and also organic substances such as stearic acid, malonic acid, ammonium salts of the abovementioned acids, starches (e.g. potato starch and maize starch), cellulose, ground nut shells, finely divided polymer flour (e.g. polyethylene, polypropylene), etc.

According to the invention, the pulverulent precursor having the stoichiometry [Mo₁₂Z¹_{c}Z²_{d}FeₑZ³_{f}Z⁴_{g}Z⁵ₕO_{y}] is preferably produced from an aqueous mixture by spray drying the latter. This means that the aqueous mixture is in this case firstly broken up into fine droplets and these are subsequently dried. According to the invention, the drying is preferably carried out in a stream of hot air. However, other hot gases (e.g. nitrogen or air diluted with nitrogen and also other inert gases) can also be used in principle for the abovementioned spray drying.

Spray drying can in principle be carried out either in cocurrent or in countercurrent of the droplets relative to the hot gas. It is preferably carried out in countercurrent of the droplets relative to the hot gas. It is particularly preferably carried out in countercurrent to a stream of hot air. Typical gas inlet temperatures are in this case in the range from 250 to 450° C., preferably from 270 to 370° C. Typical gas outlet temperatures are in this case in the range from 100 to 160° C.

According to the invention, spray drying is preferably carried out here in such a way that a desired particle diameter is obtained directly. The particle diameter d₅₀ is preferably from 30 to 45 μm. If the particle size of the resulting spray-dried powder is too small compared to the desired d₅₀, it can be coarsened by, for example, subsequent compaction to the desired particle size. Conversely, the spray-dried powder resulting from spray drying can, if required, also be made finer by milling to a desired particle size.

Of course, the intimate aqueous mixture can also be firstly dried by conventional evaporation (preferably under reduced pressure; the drying temperature should normally not exceed 150° C.) and the resulting dry composition can be brought to a required particle size by subsequent comminution. However, drying of the aqueous mixture can in principle also be carried out by freeze drying.

Preferred stoichiometries [Mo₁₂Z¹_{c}Z²_{d}FeₑZ³_{f}Z⁴_{g}Z⁵ₕO_{y}] are Mo₁₂Co_{6.0}Fe_{3.0}Si_{1.6}K_{0.08}, or Mo₁₂Co_{6.5}Fe_{3.0}Si_{1.6}K_{0.05}, or Mo₁₂Co_{7.0}Fe_{3.0}Si_{1.6}K_{0.05}, or Mo₁₂Co_{5.0}Fe_{3.0}Si_{1.6}K_{0.05}, or Mo₁₂Co_{4.5}Fe_{3.0}Si_{1.6}K_{3.05}, or Mo₁₂Co_{5.5}Fe_{2.5}Si_{1.6}K_{0.05}, or Mo₁₂Co_{5.5}Fe_{3.5}Si_{1.6}K_{0.05}, or Mo₁₂Co_{5.5}Fe_{4.0}Si_{1.6}K_{3.05}, or Mo₁₂Co_{7.0}Fe_{4.0}Si_{1.6}K_{0.08}, or Mo₁₂Co_{6.0}Fe_{3.5}Si_{1.6}K_{0.08}, or Mo₁₂Co_{7.0}Fe_{2.0}Si_{1.6}K_{0.08}, or Mo₁₂Co_{6.5}Fe_{2.5}Si_{1.6}K_{0.08}, or Mo₁₂Co_{5.5}Fe_{3.0}S_{10.5}K_{5.08}, or Mo₁₂Co_{5.5}Fe_{3.0}Si₃K_{0.05}, or Mo₁₂Co_{5.5}Fe_{3.0}Si_{1.6}K_{0.04}, or Mo₁₂Co_{5.5}Fe_{3.0}Si_{1.6}K_{0.2}, or Mo₁₂Ni_{3.0}Co_{2.5}Fe_{3.0}Si_{1.6}K_{0.08}, or Mo₁₂Ni_{3.0}Co₄Fe_{3.0}Si_{1.6}K_{0.083} or Mo₁₂Sb_{0.2}Co_{4.2}Fe_{1.4}Zn_{0.2}W_{0.1}K_{0.06}, or Mo₁₂Sb_{0.2}Co_{4.2}Fe_{1.4}Zn_{0.2}Bi_{0.9}W_{0.1}K_{0.06}, or Mo₁₂Ni_{2.8}Co_{5.2}Fe_{1.8}K_{0.1}, or Mo₁₂Ni_{2.8}Co_{5.2}Fe_{1.8}Bi_{1.7}K_{0.1}, or Mo₁₂Co₅Fe₁Ni₃W_{0.5}K_{0.1}, or Mo₁₂Co₅Fe₁Ni₃W_{0.5}Bi₁K_{0.1}, or Mo₁₂Co_{5.5}Fe_{3.0}Bi_{0.02}Si_{1.61}K_{0.08}, or Mo₁₂Co_{5.5}Fe_{3.0}Bi_{0.05}Si_{1.6}K_{0.08}, or Mo₁₂Co_{5.5}Fe_{3.0}Bi_{0.1}Si_{1.6}K_{0.08}, or Mo₁₂Co_{5.5}Fe_{3.0}Bi_{0.2}Si_{1.6}K_{0.08}, or Mo₁₂Co_{5.5}Fe_{3.0}Bi_{0.5}Si_{1.6}K_{0.08}, or Mo₁₂Co₇Fe_{3.0}Bi_{0.06}Si_{1.6}K_{0.08}, or Mo₁₂Co_{5.5}Fe_{3.0}Gd_{0.05}Si_{1.61}K_{0.08}, or Mo₁₂Co_{5.5}Fe_{3.0}Y_{0.05}Si_{1.6}K_{0.08}, or Mo₁₂Co_{5.5}Fe_{3.5}Er_{0.05}Si_{1.6}K_{0.05}, or Mo₁₂Co_{5.5}Fe_{3.0}Er_{0.25}Si_{1.6}K_{0.08}, or Mo₁₂Co_{5.5}Fe_{3.0}Sm_{0.05}Si_{1.6}K_{0.08}, or Mo₁₂Co_{5.5}Fe_{3.0}Eu_{0.05}Si_{1.6}K_{0.08}, or Mo₁₂Co_{5.5}Fe_{3.0}Dy_{0.05}Si_{1.6}K_{0.08}, or Mo₁₂Co_{5.5}Fe_{3.0}Yb_{0.05}Si_{1.6}K_{0.08}, or Mo₁₂Co_{5.5}Fe_{3.0}Tb_{0.05}Si_{1.6}K_{0.08}, or Mo₁₂Co_{5.5}Fe_{3.0}H_{0.05}Si_{1.6}K_{0.08}, or Mo₁₂Co_{5.5}Fe_{3.0}Ce_{0.05}Si_{1.6}K_{0.08}, or Mo₁₂Co_{5.5}Fe_{3.0}La_{0.05}Si_{1.6}K_{0.08}.

In the preparation of the finely divided starting composition from the mixed oxide Bi₁W_{b}Oₓ and the pulverulent precursor having the stoichiometry [Mo₁₂Z¹_{c}Z²_{d}FeₑZ³_{f}Z⁴_{g}Z⁵ₕO_{y}], it is technologically advantageous, but not absolutely necessary, to make concomitant use of finely divided shaping aids.

These can be mixed into the mixed oxide Bi₁W_{b}Oₓ and the pulverulent precursor having the stoichiometry [Mo₁₂Z¹_{c}Z²_{d}FeₑZ³_{f}Z⁴_{g}Z⁵ₕO_{y}] or into only one of the two finely divided starting compositions even before mixing is carried out. Of course, however, the finely divided shaping aids can also or only be mixed into the finely divided mixture of mixed oxide Bi₁W_{b}Oₓ and the pulverulent precursor having the stoichiometry [Mo₁₂Z¹_{c}Z²_{d}FeₑZ³_{f}Z⁴_{g}Z⁵ₕO_{y}].

The group of finely divided shaping aids includes firstly anticaking agents. These are finely divided materials which are technologically advantageously concomitantly used in order to suppress, for example, reagglomeration (“caking”) of particles to a substantial extent during mixing, since such reagglomeration could influence the effective particle diameter. One group of finely divided anticaking agents which is preferred according to the invention is formed by finely divided hydrophobicized silicas, in particular finely divided hydrophobicized synthetic silicas (silicon dioxides). Synthetic silicas can firstly be produced directly by pyrogenic means from sand and secondly be produced by precipitation reactions from water glass. Synthetic silicas in particular are hydrophilic, i.e. they are wetted by water, due to the OH groups on their surface. Reaction of these surface OH groups with chlorosilanes, for example, makes it possible to produce hydrophobicized products both from the pyrogenic silicas and the precipitated silicas. Commercial products composed of hydrophobicized precipitated silicas are, for example, the SIPERNAT® grades.

According to the invention, Sipernat® D17 from Degussa or from EVONIK Industries, 64293 Darmstadt, Germany, is preferably concomitantly used as finely divided anticaking agent. Sipernat® D17 comprises about 2% by weight, based on its weight, of chemically bound carbon and is not wetted by water. Its tapped density (in accordance with ISO 787-11) is 150 g/1. Its d₅₀ is 10 μm (laser light scattering in accordance with ISO 13320-1) and the specific surface area (nitrogen adsorption in accordance with ISO 5794-1, annex D) is 100 m²/g.

Finely divided anticaking agent such as Sipernat® D17 is advantageously mixed into the finely divided mixed oxide Bi₁W_{b}Oₓ before the latter is mixed with the finely divided precursor having the stoichiometry [Mo₁₂Z¹_{c}Z²_{d}FeₑZ³_{f}Z⁴_{g}Z⁵ₕO_{y}]. In general, the amount of finely divided anticaking agent added is from 0.1 to 3% by weight, based on the weight of the finely divided mixed oxide Bi₁W_{b}Oₓ.

The addition of anticaking agent also reduces the energy input required for homogeneous mixing of the two starting compositions.

If the shaping according to the invention of the finely divided mixture to give the geometric shaped bodies is carried out by densification (compression or compacting), it is technologically advantageous to add lubricants such as graphite, carbon black, polyethylene glycol, polyacrylic acid, stearic acid, starch, mineral oil, vegetable oil, water, boron trifluoride and/or boron nitride as further finely divided shaping aids to the starting composition. Concomitant use of lubricants in such a shaping operation is described, for example, in the documents DE-A 10 2007 004961, WO 2005/030393, US-A 2005/0131253, WO 2007/017431, DE-A 10 2007 005606 and the German patent application No. 10 2008 040093.9. According to the invention, preference is given to concomitantly using exclusively finely divided graphite as lubricant. Graphites which are preferably added are Asbury 3160 and Asbury 4012 from Asbury Graphite Mills, Inc. New Jersey 08802, USA, and Timrex® T44 from Timcal Ltd., 6743 Bodio, Switzerland.

The finely divided graphite (typical d₉₀ values of graphites which are suitable for the purposes of the invention are from 30 to 300 μm) is advantageously added only to the mixture of mixed oxide Bi₁W_{b}Oₓ with the precursor having the stoichiometry [Mo₁₂Z¹_{c}Z²_{d}FeₑZ³_{f}Z⁴_{g}Z⁵ₕO_{y}]. However, it can also be mixed into each of these (or into only one of the two) before mixing of the two finely divided starting compositions. Based on the weight of the finely divided mixture, this can comprise, for example, up to 15% by weight of finely divided lubricant. However, the lubricant content of the finely divided mixture is usually ≦9% by weight, frequently ≦5% by weight, often ≦4% by weight, especially when the finely divided lubricant is graphite. In general, the abovementioned amount added is ≧0.5% by weight, usually ≧2.5% by weight.

If required, finely divided reinforcing materials such as microfibers composed of glass, asbestos, silicon carbide or potassium titanate can be added as further shaping aids to the finely divided mixture; after completion of shaping by densification, these promote the cohesion of the compact obtained (the resulting shaped body).

During the thermal treatment according to the invention of the shaped bodies, in which the shaped catalyst bodies develop, concomitantly used shaping aids can either remain in the resulting shaped catalyst body or be at least partly given off in gaseous form from this by thermal and/or chemical decomposition to form gaseous compounds (e.g. CO, CO₂).

The densification of the finely divided mixture of the mixed oxide Bi₁W_{b}Oₓ and the precursor having the stoichiometry [Mo₁₂Z¹_{c}Z²_{d}FeₑZ³_{f}Z⁴_{g}Z⁵ₕO_{y}] to give the desired geometry of the shaped body (the geometric shaped catalyst precursor body) is generally effected by application of external forces (pressure) to the finely divided precursor mixture. The shaping apparatus to be employed or the shaping method to be employed here is not subject to any restriction.

For example, the densifying shaping can be effected by continuous pressing, tableting or extrusion. Here, the finely divided mixture is preferably used in a dry-to-the-touch state. However, it can, for example, contain up to 10% of its total weight of substances which are liquid under standard conditions (25° C., 1 atm). The finely divided mixture can also comprise solid solvates (e.g. hydrates) which comprise such liquid substances in chemically and/or physically bound form. Of course, the finely divided mixture can also be completely free of such substances.

A process for shaping by densification which is preferred according to the invention is tableting. The basic principles of tableting are described, for example, in “Die Tablette”, Handbuch der Entwicklung, Herstellung and Qualittätssicherung, W. A. Ritschel and A. Bauer-Brandl, 2nd edition, Edition Verlag Aulendorf, 2002, and can be applied in a completely analogous way to a tableting process according to the invention.

A tableting operation according to the invention is advantageously carried out as described in the documents WO 2005/030393, DE 10 2008 040093, DE 10 2008 040094 and WO 2007/017431.

Instead of densifying the finely divided mixture as such directly to produce the desired geometry of the shaped body (in a single densification step), it is frequently advantageous according to the invention firstly to carry out an intermediate compaction operation as a first shaping step in order to coarsen the finely divided mixture (generally to particle diameters of from 100 to 2000 μm, preferably from 150 to 1500 μm, particularly preferably from 400 to 1250 μm, or from 400 to 1000 μm, or from 400 to 800 μm).

Here, for example, finely divided lubricant (e.g. graphite) can be added even before the intermediate compaction operation. The final shaping is subsequently carried out on the basis of the coarsened powder, with, for example, finely divided lubricant (e.g. graphite) and optionally further shaping aid and/or reinforcing material once again being able to be added beforehand if required.

Like the shaping apparatus to be used for densifying the finely divided mixture or the shaping method to be employed in this case, the desired geometry of the resulting shaped bodies is also not subject to any restriction in the process of the invention, i.e. the shaped catalyst precursor bodies (the shaped bodies) can have either a regular or irregular shape, with shaped bodies having a regular shape generally being preferred according to the invention.

For example, the shaped body can have a spherical geometry in the process of the invention. Here, the sphere diameter can be, for example, from 2 to 10 mm, or from 4 to 8 mm. However, the geometry of the shaped catalyst precursor body can also be that of a solid cylinder or hollow cylinder (annular). In both cases, external diameter (A) and height (H) can be, for example, from 2 to 10 mm, or from 2 or 3 to 8 mm. In the case of solid cylinders, the external diameter can also be from 1 to 10 mm. In the case of hollow cylinders (rings), a wall thickness of from 1 to 3 mm is generally advantageous. Of course, all geometries as are disclosed and recommended in WO 02/062737 are also possible as catalyst precursor geometry.

The shaping pressures applied during densification of the finely divided mixture in the process of the invention will generally be from 50 kg/cm² to 5000 kg/cm². The shaping pressures are preferably from 200 to 3500 kg/cm², particularly preferably from 600 to 25 000 kg/cm².

Especially in the case of annular shaped bodies, the shaping densification in the process of the invention should, following the teaching of the documents DE 10 2008 040093, DE 10 2008 040094 and WO 2005/030393, be carried out in such a way that the lateral compressive strength SD of the resulting annular shaped body V is such that 12 N≦SD≦25 N. SD is preferably ≧13 N and ≦24 N, or ≧14 N and ≦22 N and very particularly preferably ≧15 N and ≦20 N.

The experimental determination of the lateral compressive strength is carried out here as described in the documents WO 2005/030393 and WO 2007/017431. Of course, ring-like shaped bodies as are recommended in DE 10 2008 040093 are very particularly preferred according to the invention. The end face of annular or ring-like shaped bodies V can be both curved and uncurved in the process of the invention (cf., in particular, DE 10 2007 004961, EP-A 184 790 and DE 10 2008 040093). When determining the height of such geometric shaped bodies, such a curvature is not taken into account.

Shaped catalyst bodies obtainable according to the invention which have been produced by thermal treatment of shaped bodies which have been obtained by densification of a finely divided starting composition are referred to as all-active catalysts (shaped all-active catalyst bodies).

Particularly advantageous, for the purposes of the invention, annular geometries of shaped bodies obtainable by densification of a finely divided mixture of mixed oxide Bi₁W_{b}Oₓ with a precursor having the stoichiometry [Mo₁₂Z¹_{c}Z²_{d}FeₑZ³_{f}Z⁴_{g}Z⁵ₕO_{y}] satisfy the condition H/A (where H is the height and A is the external diameter of the annular geometry)=0.3 to 0.7. Particular preference is given to H/A=0.4 to 0.6. Furthermore, it is advantageous according to the invention for the ratio 1/A (where I is the internal diameter of the annular geometry) of the abovementioned annular shaped bodies V to be from 0.3 to 0.7, preferably from 0.4 to 0.7.

Annular geometries of the abovementioned type which at the same time have one of the advantageous H/A ratios and one of the advantageous I/A ratios are particularly advantageous. Possible combinations of this type are, for example, H/A=0.3 to 0.7 and I/A=0.3 to 0.8 or 0.4 to 0.7. As an alternative, H/A can be from 0.4 to 0.6 and I/A can at the same time be from 0.3 to 0.8 or from 0.4 to 0.7. Furthermore, it is advantageous for the relevant annular geometries for H to be from 2 to 6 mm and preferably from 2 to 4 mm. It is also advantageous for A of the rings to be from 4 to 8 mm, preferably from 4 to 6 mm. The wall thickness of annular geometries which are preferred according to the invention is from 1 to 1.5 mm.

Possible annular geometries of annular shaped bodies of the abovementioned type are thus (A×H×1) 5 mm×2 mm×2 mm, or 5 mm×3 mm×2 mm, or 5 mm×3 mm×3 mm, or 5.5 mm×3 mm×3.5 mm, or 6 mm×3 mm×4 mm, or 6.5 mm×3 mm×4.5 mm, or 7 mm×3 mm×5 mm, or 7 mm×7 mm×3 mm, or 7 mm×7 mm×4 mm.

The thermal treatment of shaped bodies according to the invention (in particular annular shaped bodies; all the following applies in particular to the thermal treatment thereof) to give the geometric shaped catalyst bodies is generally carried out at temperatures (which in the present text means the temperature within the material being calcined) which exceed 350° C. in the process of the invention. However, a temperature of 650° C. is normally not exceeded during the thermal treatment. It is advantageous for the purposes of the invention for a temperature of 600° C., preferably a temperature of 550° C. and particularly preferably a temperature of 500° C., not to be exceeded during the thermal treatment.

Furthermore, a temperature of 380° C., advantageously a temperature of 400° C., particularly advantageously a temperature of 420° C. and very particularly preferably a temperature of 440° C., is preferably exceeded during the thermal treatment of the shaped bodies. The thermal treatment can also be divided in this case into a number of sections over time. For example, a thermal treatment at a temperature (phase 1) of from 150 to 350° C., preferably from 220 to 290° C., can firstly be carried out and a thermal treatment at a temperature (phase 2) of from 400 to 600° C., preferably from 430 to 550° C., can subsequently be carried out.

The thermal treatment of the shaped bodies normally takes a number of hours (frequently more than 5 hours). The total duration of the thermal treatment is frequently more than 10 hours. Treatment times of 45 hours or 25 hours are usually not exceeded during the thermal treatment of the shaped bodies. The total treatment time is often less than 20 hours. In principle, the thermal treatment can be carried out at relatively high temperatures over a relatively short treatment time or at temperatures which are not too high over a longer treatment time. In an embodiment of the thermal treatment of the shaped bodies which is advantageous for the purposes of the invention, 465° C. is not exceeded and the treatment time in the temperature window of 440° C. is from >10 to 20 hours. In another embodiment which is advantageous according to the invention (and is preferred for the purposes of the invention) of the thermal treatment of the shaped bodies, 465° C. (however not 500° C.) is exceeded and the treatment time in the temperature window of 465° C. is from 2 to 10 hours.

The thermal treatment (also known as phase 1 (also decomposition phase)) of the shaped bodies V can be carried out either under inert gas or under an oxidative atmosphere such as air (or another mixture of inert gas and oxygen) or under a reducing atmosphere (e.g. a mixture of inert gas, NH₃, CO and/or H₂ or under methane, acrolein, methacrolein). It goes without saying that the thermal treatment can also be carried out under reduced pressure. The calcination atmosphere can also be varied over the calcination time. According to the invention, the thermal treatment of the shaped bodies is preferably carried out in an oxidizing atmosphere. This technologically advantageously consists predominantly of static or moving air.

The thermal treatment of the shaped bodies can in principle be carried out in a variety of furnace types such as heatable convection chambers (convection furnaces), tray furnaces, rotary tube furnaces, belt calciners or shaft furnaces. According to the invention, the thermal treatment of the shaped bodies V is advantageously carried out in a belt calcination apparatus as recommended in DE-A 10046957 and WO 02/24620. Formation of a hot spot within the material being calcined is largely avoided by increased volume flows of calcination atmosphere being conveyed through the material being calcined through a gas-permeable conveyor belt carrying the material being calcined by means of fans.

The thermal treatment of the shaped bodies below 350° C. generally pursues the objective of thermal decomposition of the sources of the elements (the elemental constituents) of the desired multielement oxide I active composition of the shaped catalyst bodies comprised in the shaped bodies and of shaping aids which are optionally concomitantly used. This decomposition phase frequently occurs at temperatures of 350° C. during the heating of the material being calcined.

The thermal treatment can in principle be carried out as described in US 2005/0131253.

The lateral compressive strengths of annular all-active shaped catalyst bodies obtainable as described according to the invention are typically from 5 to 13 N, frequently from 8 to 11 N.

All-active shaped catalyst bodies produced according to the invention can also be subjected to milling and the resulting finely divided material (optionally after classification of the resulting finely divided material) be applied with the aid of a suitable liquid binder (e.g. water) to the surface of a suitable, e.g. spherical or annular, support body (geometric shaped support body) (e.g. using the process principle disclosed in DE-A 2909671 or DE-A 100 51 419). After drying or immediately after application of the active composition coating to the support body, the resulting coated catalyst can be used as catalyst for heterogeneously catalyzed gas-phase partial oxidations as mentioned above, as is described, for example, by WO 02/49757 and DE-A 10122027 for similar active compositions.

As support materials, it is possible to use conventional porous or nonporous aluminum oxides, silicon dioxide, zirconium dioxide, silicon carbide or silicates such as magnesium silicate or aluminum silicate in the above process. The support bodies can have a regular or irregular shape, with preference being given to support bodies which have a regular shape and have a pronounced surface roughness (e.g. the abovementioned spheres or rings). The use of essentially nonporous, rough (on the surface) rings of steatite whose longitudinal extension (longest direct straight connecting line between two points located on the surface of the shaped support body) is typically from 2 to 12 mm, frequently from 4 to 10 mm, is particularly advantageous (cf. also DE-A 4442346). The abovementioned longitudinal extensions are also possible for other shaped support bodies such as spheres, solid cylinders and other rings.

The layer thickness of the active composition coating (powder composition) applied to the shaped support body is advantageously selected in the range from 10 to 1000 μm, preferably in the range from 100 to 700 μm and particularly preferably in the range from 300 to 500 μm. Possible coating thicknesses are also from 10 to 500 μm or from 200 to 300 μm. The surface roughness Rz of the shaped support body is frequently in the range from 40 to 200 μm, often in the range from 40 to 100 μm (determined in accordance with DIN 4768 sheet 1 using a “Hommel Tester für DIN-ISO Oberflächenmallgröβen” from Hommelwerke, DE). The support material is advantageously nonporous (total volume of the pores based on the volume of the support body ≦1% by volume).

The shaping of the finely divided mixture of mixed oxide Bi₁W_{b}Oₓ with the precursor having the stoichiometry [Mo₁₂Z¹_{c}Z²_{d}FeₑZ³_{f}Z⁴_{g}Z⁵ₕO_{y}] to give a shaped body can in principle also be carried out by applying the finely divided mixture with the aid of a suitable liquid binder to the surface of a geometric shaped support body as described above. After drying, the resulting shaped precursor bodies can be thermally treated in a manner according to the invention to give shaped coated catalyst bodies according to the invention.

Active composition powder produced by milling all-active shaped catalyst bodies produced according to the invention can also be used as such in a fluidized bed or moving bed for the heterogeneously catalyzed partial gas-phase oxidations with which these documents are concerned.

However, geometric shaped catalyst bodies which can be obtained according to the invention are particularly suitable as catalysts for the partial oxidations of propene to acrolein and of isobutene and/or tert-butanol to methacrolein. This applies particularly to annular all-active shaped catalyst bodies according to the invention. The partial oxidation can be carried out, for example, as described in the documents DE-A 10 2007 004961, WO 02/49757, WO 02/24620, DE 10 2008 040093, WO 2005/030393, EP-A 575 897, WO 2007/082827, WO 2005/113127, WO 2005/047224, WO 2005/042459 and WO 2007/017431.

The proportion of propene (proportion of isobutene or tert-butanol (or the proportion of methyl ether)) in the starting reaction gas mixture will normally (i.e. essentially independently of the throughput) be from 4 to 20% by volume, frequently from 5 to 15% by volume, or from 5 to 12% by volume, or from 5 to 8% by volume (in each case based on the total volume of the starting reaction gas mixture).

The gas-phase partial oxidation process will frequently be carried out at a volume ratio of the (organic) compound to be partially oxidized (e.g. propene):oxygen:indifferent gases (including water vapor) in the starting reaction gas mixture of from 1:(1.0-3.0):(5-25), preferably 1:(1.5-2.3):(10-20).

For the purposes of the present invention, indifferent gases (or else inert gases) are gases which remain chemically unaltered to an extent of at least 95 mol %, preferably at least 98 mol %, during the course of the partial oxidation.

In the above-described starting reaction gas mixtures, the indifferent gas can comprise ≧20% by volume, or ≧30% by volume, or ≧40% by volume, or ≧50% by volume, or ≧60% by volume, or ≧70% by volume, or ≧80% by volume, or ≧90% by volume, or ≧95% by volume, of molecular nitrogen.

However, at space velocities of the organic compound to be partially oxidized over the catalyst charge of 150 standard l/l·h, the concomitant use of inert diluent gases such as propane, ethane, methane, pentane, butane, CO₂, CO, steam and/or noble gases for the starting reaction gas mixture is advisable. In general, these inert gases and mixtures thereof can also be used even at lower space velocities of the organic compound to be partially oxidized over the catalyst charge. Recycle gas can also be concomitantly used as diluent gas. For the purposes of the present invention, recycle gas is the residual gas which remains when the target compound has been essentially selectively separated off from the product gas mixture from the partial oxidation. Here, it has to be taken into account that the partial oxidations to acrolein or methacrolein using the annular, for example, shaped catalyst bodies K which can be obtained according to the invention can be only the first stage of a two-stage partial oxidation to acrylic acid or methacrylic acid as the actual target compounds, so that recycled gas formation then usually occurs only after the second stage. In such a two-stage partial oxidation, the product gas mixture from the first stage is generally fed as such, optionally after cooling and/or addition of secondary oxygen, to the second partial oxidation stage.

In the partial oxidation of propene to acrolein using the annular, for example, shaped catalyst bodies obtainable as described above, a typical composition of the starting reaction gas mixture measured at the reactor inlet (independently of the space velocity selected) can comprise, for example, the following components:

from 6 to 6.5% by volume of propene,

from 1 to 3.5% by volume of H₂O,

from 0.2 to 0.5% by volume of CO,

from 0.6 to 1.2% by volume of CO₂,

from 0.015 to 0.04% by volume of acrolein,

from 10.4 to 11.3% by volume of O₂ and

molecular nitrogen as balance to 100% by volume;

or:

5.6% by volume of propene,

10.2% by volume of oxygen,

1.2% by volume of COₓ,

81.3% by volume of N₂ and

1.4% by volume of H₂O.

Compositions of the first type are suitable, in particular, at space velocities of propene of ≧130 standard l/l·h and the latter composition is suitable, in particular, at space velocities of propene of <130 standard l/l·h, in particular ≦100 standard l/l·h, through the fixed catalyst bed.

Alternative compositions of the starting reaction gas mixture are (independently of the space velocity selected) those which have the following component contents:

from 4 to 25% by volume of propene,

from 6 to 70% by volume of propane,

from 5 to 60% by volume of H₂O,

from 8 to 65% by volume of O₂ and

from 0.3 to 20% by volume of H₂;

or:

from 4 to 25% by volume of propene,

from 6 to 70% by volume of propane,

from 0 to 60% by volume of H₂O,

from 8 to 16% by volume of O₂,

from 0 to 20% by volume of H₂,

from 0 to 0.5% by volume of CO,

from 0 to 1.2% by volume of CO₂,

from 0 to 0.04% by volume of acrolein,

and essentially N₂ as balance to 100% by volume;

or:

from 50 to 80% by volume of propane,

from 0.1 to 20% by volume of propene,

from 0 to 10% by volume of H₂,

from 0 to 20% by volume of N₂,

from 5 to 15% by volume of H₂O and

such an amount of molecular oxygen that the molar ratio of oxygen content to propene

content is from 1.5 to 2.5;

or:

from 6 to 9% by volume of propene,

from 8 to 18% by volume of molecular oxygen,

from 6 to 30% by volume of propane and

from 32 to 72% by volume of molecular nitrogen.

However, the starting reaction gas mixture can also have the following composition:

from 4 to 15% by volume of propene,

from 1.5 to 30% by volume (frequently from 6 to 15% by volume) of water,

from ≧0 to 10% by volume (preferably from ≧0 to 5% by volume)

of constituents other than propene, water, oxygen and nitrogen, such an amount of molecular oxygen that the molar ratio of molecular oxygen comprised to molecular propene comprised is from 1.5 to 2.5,

and molecular nitrogen as balance to a total amount of 100% by volume.

Another possible starting reaction gas mixture composition can comprise:

6.0% by volume of propene,

60% by volume of air and

34% by volume of H₂O.

Further starting reaction gas mixtures which are suitable according to the invention can be in the following composition range:

from 7 to 11% by volume of propene,

from 6 to 12% by volume of water,

from ≧0 to 5% by volume of propene, water, oxygen

and constituents other than nitrogen,

such an amount of molecular oxygen that the molar ratio of molecular oxygen comprised to propene comprised is from 1.6 to 2.2, and molecular nitrogen as balance to a total amount of 100% by volume.

In the case of methacrolein as target compound, the starting reaction gas mixture can, in particular, also have the composition described in DE-A 44 07 020.

When the annular, for example, shaped catalyst bodies obtainable as described above are used, the reaction temperature for the partial oxidation of propene is frequently from 300 to 380° C. The same applies in the case of methacrolein as target compound.

The reaction pressure in the abovementioned partial oxidations is generally from 0.5 or 1.5 to 3 or 4 bar (in the present text, pressures are always absolute pressures unless expressly indicated otherwise).

The total space velocity of starting reaction gas mixture over the catalyst charge is typically from 1000 to 10 000 standard l/l·h, usually from 1500 to 5000 standard l/l·h and often from 2000 to 4000 standard l/l·h, in the abovementioned partial oxidations.

As propene to be used in the starting reaction gas mixture, it is possible to use, in particular, polymer grade propene and chemical grade propene, as is described, for example, in DE-A 102 32 748.

Air is normally used as oxygen source.

The partial oxidation using the annular, for example, shaped catalyst bodies K obtainable as described above can in the simplest case be carried out, for example, in a single-zone fixed-bed reactor having a plurality of catalyst tubes, as is described in DE-A 44 31 957, EP-A 700 714 and EP-A 700 893.

In the abovementioned shell-and-tube reactors, the catalyst tubes are usually made of ferritic steel and typically have a wall thickness of from 1 to 3 mm. Their internal diameter is generally from 20 to 30 mm, frequently from 21 to 26 mm. A typical catalyst tube length is, for example, 3.20 m. The number of catalyst tubes accommodated in the shell of the shell-and-tube reactor is technologically advantageously at least 1000, preferably at least 5000. The number of catalyst tubes accommodated in the reactor shell is frequently from 15 000 to 35 000. Shell-and-tube reactors having more than 40 000 catalyst tubes tend to be the exception. Within the shell, the catalyst tubes are normally homogeneously distributed, with the distribution advantageously being selected so that the distance between the central axes of nearest-neighbor catalyst tubes (known as the catalyst tube spacing) is from 35 to 45 mm (cf. EP-B 468 290).

However, the partial oxidation can also be carried out in a multizone (e.g. “two-zone”) fixed-bed reactor having a plurality of catalyst tubes, as recommended by DE-A 199 10 506, DE-A 103 13 213, DE-A 103 13 208 and EP-A 1 106 598, especially at elevated space velocities of the organic compound to be partially oxidized over the catalyst charge. A typical catalyst tube length in the case of a two-zone fixed-bed reactor having a plurality of catalyst tubes is 3.50 m. Everything else is essentially as described for the single-zone fixed-bed reactor having a plurality of catalyst tubes. Around the catalyst tubes, within which the catalyst charge is present, a heat transfer medium is conveyed in each temperature-controlled zone. Suitable heat transfer media are, for example, melts of salts such as potassium nitrate, potassium nitrite, sodium nitrite and/or sodium nitrate, or of low-melting metals such as sodium, mercury and alloys of various metals. The flow rate of the heat transfer medium within the respective temperature-controlled zone is generally selected so that the temperature of the heat transfer medium increases from the entry point into the temperature zone to the exit point from the temperature zone by from 0 to 15° C., frequently from 1 to 10° C., or from 2 to 8° C., or from 3 to 6° C.

The inlet temperature of the heat transfer medium which, viewed over the respective temperature-controlled zone, can be conveyed in cocurrent or in countercurrent relative to the reaction gas mixture is preferably selected as recommended in the documents EP-A 1 106 598, DE-A 199 48 523, DE-A 199 48 248, DE-A 103 13 209, EP-A 700 714, DE-A 103 13 208, DE-A 103 13 213, WO 00/53557, WO 00/53558, WO 01/36364, WO 00/53557 and the other documents cited as prior art in the present text. Within the temperature-controlled zone, the heat transfer medium is preferably conveyed in a meandering fashion. In general, the fixed-bed reactor having a plurality of catalyst tubes additionally has thermotubes for determining the gas temperature in the catalyst bed. The internal diameter of the thermotubes and the diameter of the accommodation sheath located inside for the thermocouple are advantageously selected so that the ratio of volume evolving heat of reaction to surface area which removes heat is the same or only slightly different for thermotubes and working tubes.

The pressure drop should be the same for working tubes and thermotubes, based on the same GHSV. A pressure drop equalization for the thermotube can be effected by addition of crushed catalyst to the shaped catalyst bodies. This equalization advantageously occurs homogeneously over the entire thermotube length.

To provide the catalyst charge in the catalyst tubes, it is possible, as mentioned above, for only annular, for example, shaped catalyst bodies obtained as described above or, for example, also largely homogeneous mixtures of annular, for example, shaped catalyst bodies obtainable as described above and shaped bodies which do not comprise any active composition and are essentially inert in respect of the heterogeneously catalyzed partial gas-phase oxidation to be used. Possible materials for such inert shaped bodies are, for example, porous or nonporous aluminum oxides, silicon dioxide, zirconium dioxide, silicon carbide, silicates such as magnesium silicate or aluminum silicate and/or steatite (e.g. of the type C220 from CeramTec, 73207 Plochingen, Germany).

Such inert shaped diluent bodies can in principle have any geometry, i.e. they can be, for example, spheres, polygons, solid cylinders or, as in the case of, for example, annular shaped catalyst bodies, rings. Inert shaped diluent bodies whose geometry corresponds to that of the shaped catalyst bodies to be diluted therewith will frequently be chosen. However, the geometry of the shaped catalyst body can also be changed along the catalyst charge or shaped catalyst bodies K of differing geometry can be used in a largely homogeneous mixture. In a less preferred procedure, the active composition of the shaped catalyst body can also be changed along the catalyst charge.

Quite generally, the catalyst charge will, as mentioned above, advantageously be configured in such a way that the volume-specific activity (i.e. the activity standardized to the unit of volume) either remains constant or increases (continuously, suddenly or in steps) in the flow direction of the reaction gas mixture.

A reduction in the volume-specific activity can be achieved in a simple way by, for example, homogeneously diluting a basic amount of annular, for example, shaped catalyst bodies produced uniformly according to the invention with inert shaped diluent bodies. The higher the proportion of the shaped diluent bodies selected, the lower the active composition present in a particular volume of the charge or the lower the catalyst activity. However, a reduction can also be achieved by altering the geometry of the shaped catalyst bodies K which are obtainable according to the invention in such a way that the amount of active composition comprised in the unit of the interior volume of the reaction tube becomes smaller.

For the heterogeneously catalyzed gas-phase partial oxidations using annular all-active shaped catalyst bodies obtainable as described above, the catalyst charge is preferably either uniform with only one type of all-active annular shaped catalyst bodies along the entire length or is structured as follows. At the reactor inlet, an essentially homogeneous mixture of annular all-active shaped catalyst body obtainable according to the invention and inert shaped diluent body (with both preferably having essentially the same geometry) is placed over a length of from 10 to 60%, preferably from 10 to 50%, particularly preferably from 20 to 40% and very particularly preferably from 25 to 35% (i.e., for example, over a length of from 0.70 to 1.50 m, preferably from 0.90 to 1.20 m), in each case based on the total length of the catalyst charge, where the proportion by weight of the shaped diluent bodies (the body densities of shaped catalyst bodies and of shaped diluent bodies generally differ only slightly) is normally from 5 to 40% by weight, or from 10 to 40% by weight, or from 20 to 40% by weight, or from 25 to 35% by weight. Subsequent to this first charge section, there is then advantageously either a bed of the annular all-active shaped catalyst body obtained as described above which has been diluted only to a small extent (compared to the first section) or, very particularly preferably, a single (undiluted) bed of the same annular all-active shaped catalyst bodies which has also been used in the first section through to the end of the length of the catalyst charge (i.e., for example, over a length of from 1.00 to 3.00 m or from 1.00 to 2.70 m, preferably from 1.40 to 3.00 m, or from 2.00 to 3.00 m). Naturally, a constant dilution over the entire charge can also be selected. The first section can also be charged only with an annular all-active shaped catalyst body obtainable according to the invention having a low active composition density based on the volume occupied and the second section can be charged with an annular all-active shaped catalyst body which is obtainable according to the invention and has a high active composition density based on the volume occupied (e.g. 6.5 mm×3 mm×4.5 mm [A×H×I] in the first section, and 5×2×2 mm in the second section).

Overall, the catalyst charge, the starting reaction gas mixture, the space velocity and the reaction temperature in a partial oxidation for preparing acrolein or methacrolein carried out using the annular, for example, shaped catalyst bodies obtainable as described above as catalysts are generally selected so that a conversion of the organic compound to be partially oxidized (propene, isobutene, tert-butanol or the methyl ether thereof) of at least 90 mol %, or at least 92 mol %, preferably at least 94 mol %, is obtained for a single pass of the reaction gas mixture through the catalyst charge. The selectivity of acrolein or methacrolein formation will normally be ≧80 mol % or ≧85 mol % in this case. The lowest possible hot spot temperatures are naturally sought in this case.

In conclusion, it can be said that annular all-active shaped catalyst bodies obtainable as described above also have an advantageous fracture behavior during charging of the reactor.

The startup of a fresh catalyst charge comprising geometric shaped catalyst bodies obtainable according to the invention (fixed catalyst bed) can, for example, be carried out as described in DE-A 103 37 788.

In general, activity and selectivity to target product formation initially increase with the time of operation of the catalyst charge before an aging-related decrease therein occurs. This catalyst activation can be accelerated by carrying it out at essentially the same conversion with an increased space velocity of the starting reaction gas mixture over the catalyst charge and bringing the space velocity back to its target value after catalyst activation is largely complete.

Moreover, geometric shape catalyst bodies obtainable according to the invention are quite generally suitable as catalysts for gas-phase catalytic partial oxidations of alkanes comprising from 3 to 6 (i.e. 3, 4, 5 or 6) carbon atoms (in particular propane), alkanols, alkanals, alkenes and alkenals to, for example, olefinically unsaturated aldehydes and/or carboxylic acids, and also to the corresponding nitriles (ammoxidation, especially of propene to acrylonitrile and of 2-methylpropene or tert-butanol (or the methyl ether thereof) to methacrylonitrile) and also for gas-phase catalytic oxidative dehydrogenations of the abovementioned organic compounds comprising 3, 4, 5 or 6 carbon atoms.

The invention is illustrated in more detail by the accompanying figures and the following examples.

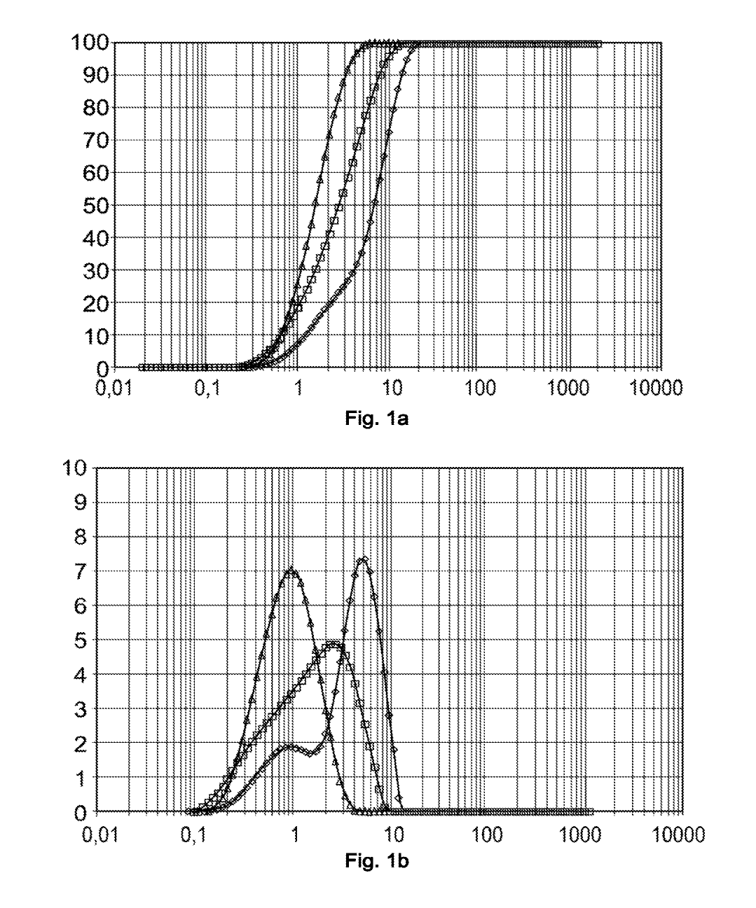

FIGS. 1a and 1b show the size distribution of the particles of the precipitated Bi—W product;

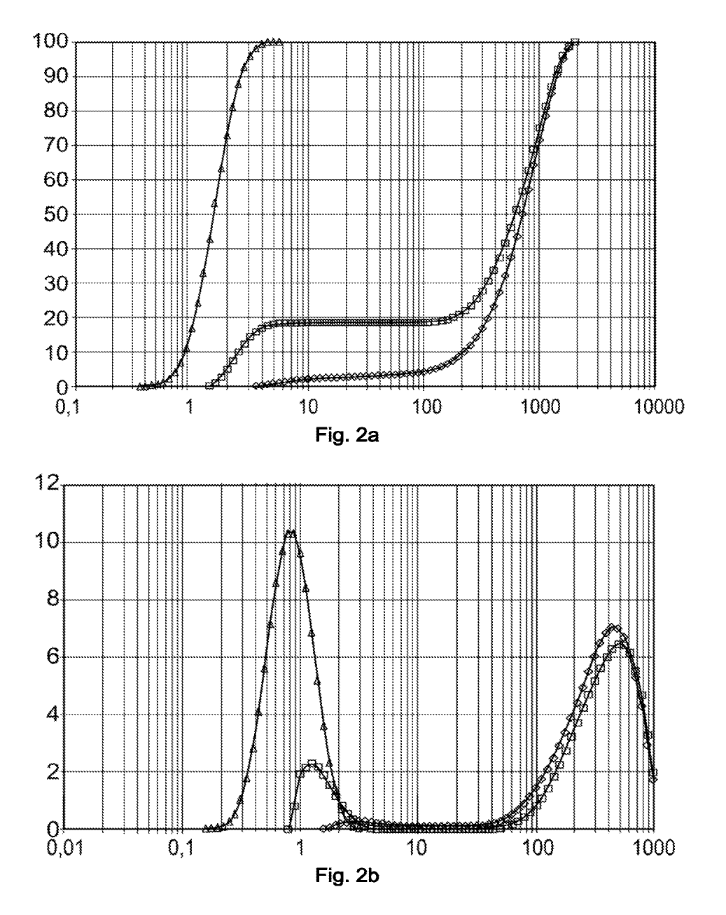

FIGS. 2a and 2b show the particle size distributions of the calcined starting composition A1 as a function of the dispersing pressure applied;

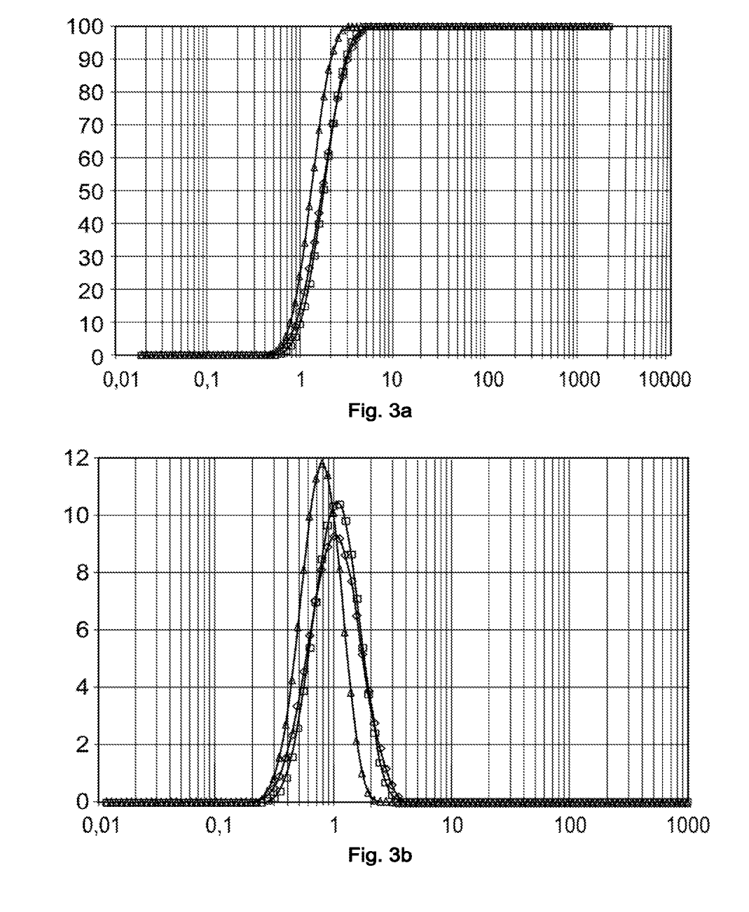

FIGS. 3a and 3b show the particle size distributions of the calcined and milled starting composition A1 as a function of the duration of the pretreatment with ultrasound;

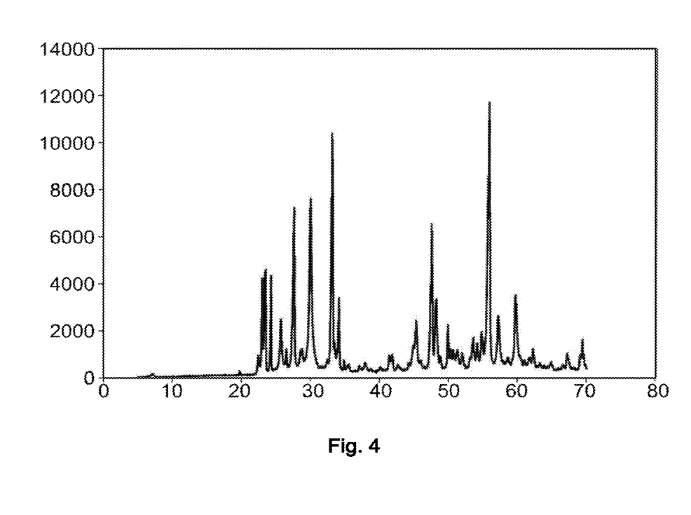

FIG. 4 shows the XRD pattern of the milled calcined starting composition A1;

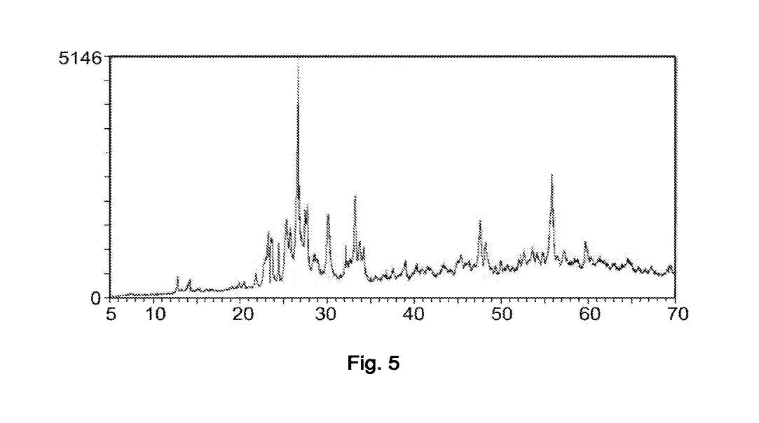

FIG. 5 shows the XRD pattern of the calcined all-active shaped catalyst precursor body ES; and

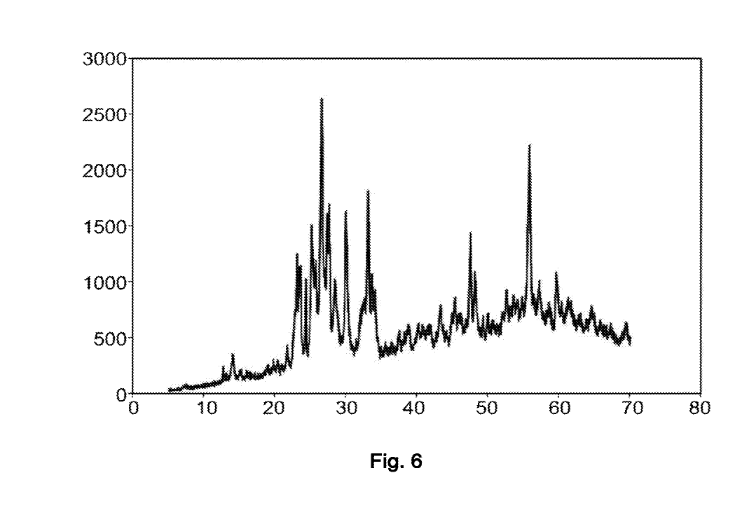

FIG. 6 shows the XRD pattern of the calcined all-active shaped catalyst precursor body VS.

### METHODS

The dry particle diameter distributions were determined by means of laser light scattering as follows. The multielement oxide composition powder was introduced via a dispersing chute into the dry disperser Scirocco 2000 (Malvern Instruments, Worcestershire WR14 1AT, United Kingdom), there dispersed dry by means of compressed air (which had the respective dispersing pressure of 1.2 or 2 or 4.5 bar abs.) and blown as a free stream into the measurement cell. In this, the volume-based particle diameter distribution was then determined in accordance with ISO 13320 using the laser light scattering spectrometer Malvern Mastersizer 2000 (Malvern Instruments, Worcestershire WR14 1AT, United Kingdom) (obscuration from 3 to 7%).

Volume-based particle size distributions in suspension were determined using the laser light scattering spectrometer Malvern Mastersizer 2000 (Malvern Instruments, Worcestershire WR14 1AT, United Kingdom). Here, 3.5 g of the multielement oxide composition powder were in each case treated at 100% ultrasound intensity in 100 ml of water with addition of 5% by weight of Spulfix (Deutsche Hahnerol GmbH, 30453 Hanover, Germany) in a Hydro 2000 G ultrasonic bath from Malvern Instruments for a period of 1, 3 and 5 minutes. The suspension was then pumped by means of a pump directly into the laser light scattering spectrometer (pump revolutions=2500 rpm) and measured directly. The particle size distribution was indicated as a function of the time in the ultrasonic bath.

### Examples and Comparative Examples

### Example 1

### Production of Annular all-Active Shaped Catalyst Bodies ES According to the Invention Having the Following Stoichiometry of the Active Composition

[Bi₁W₂O_{7.5}]ₐ[Mo₁₂Co_{5.5}Fe_{3.0}Si_{1.6}K_{0.08}Oₓ]₁

### a) Preparation of the finely divided starting compositions A1 (Bi₁W₂O₇₅=½ Bi₂W₂O₉*1WO₃)

In a 10 l glass beaker, the pH of a bismuth nitrate solution (mass=182.7 g corresponding to 1.3 mol of Bi, from BASF SE, 67056 Ludwigshafen, Germany) was set to 2.0 at 25° C. over a period of 1 hour by means of 15% strength NaOH solution (1030 g of solution corresponding to 154.5 g of NaOH=3.86 mol of Na, from Merck KGaA, 64293 Darmstadt, Germany) while stirring continually by means of a toothed disk stirrer from IKA (diameter: 80 mm, 820 rpm; stirring apparatus: laboratory stirrer IKA RW20, from IKA®-Werke GmbH & Co. KG, 79219 Staufen, Germany). The pH was determined by means of a glass electrode model Orbisint CPS71-D (from Endress & Hauser, 79576 Weil am Rhein, Germany). 658.2 g of tungstic acid (=2.6 mol of W, from BASF SE, 67056 Ludwigshafen, Germany) which had been slurried beforehand in 1313 g of demineralized water were added to the above suspension over a period of 20 minutes while maintaining the pH. The constant pH was achieved by further addition of 15% strength NaOH solution (26 g of solution corresponding to 3.9 g of NaOH=0.1 mol of Na, from Merck KGaA, 64293 Darmstadt, Germany). The solution was then in each case allowed to stand for 1 hour for decantation. The suspension was then stirred for another 3 hours at 25° C. The solution was then decanted three times with continuous measurement of the conductivity by means of a potentiometer model HI8733 (Hanna Instruments GmbH, 89269 Vohringen, Germany), which led to a decrease in the conductivity from 1900 μS to <1000 μS. In each decantation step, from 3000 to 4000 ml of demineralized water were removed and added again. The suspension was then filtered through a porcelain suction filter having a diameter of 260 mm and provided with a PP needled felt filter cloth (from M&K Filze GmbH, 91174 Spalt, Germany; surface area=600 g/m², permeability 20 l; height of the filter cake 40 mm). The filter cake was repeatedly washed with demineralized water until a conductivity of <400 μS had been achieved. The resulting filter cake was dried at 110° C. in a convection drying oven model T5060E (from Heraeus, 63450 Hanau, Germany) until a constant weight had been achieved after 16 hours.

The proportion of Na in the dried filter cake, which was determined by flame atomic absorption spectroscopy on a flame atomic absorption spectrometer SpectrAA-700 (Spectro Analytical Instruments GmbH, 47533 Kleve, Germany), was below the detection limit. The molar Bi/W ratio determined by X-ray fluorescence analysis using an Axios sequential X-ray spectrometer (from PANalytical GmbH, 34123 Kassel, Germany) was 2:1 in this catalyst.

The size distribution of the particles of the precipitated product is shown in FIGS. 1a and 1b as a function of the dispersing pressure of the compressed air used for dry dispersing (⋄=1.2 bar abs.; 58=1=2.0 bar abs.; Δ=4.5 bar abs.). In FIG. 1a, the abscissa shows the particle diameter (the particle dimension) in μm on a logarithmic scale (logarithm to the base 10) and the ordinate value on the distribution curve corresponding to a particular particle diameter on the abscissa shows the X-% of the total particle volume made up of particles having this particle dimension. In FIG. 1b, the abscissa again shows the particle diameter (particle dimension) in μm on a logarithmic scale (logarithm to the base 10). However, the ordinate in this case shows the proportion by volume of the total particle volume made up of particles having the respective diameter or a smaller diameter.

The dried starting composition A1 was subsequently calcined in a rotary bulb furnace (type: in-house construction by BASF SE). For this purpose, 200 g of the dried powder were in each case placed in a 1 l round-bottom flask and calcined in air (air flow: 50 standard l/h) at a constant rate of rotation of 10 rpm. The temperature increases were carried out essentially linearly over time. During 4 hours, the material was heated from 25° C. to 300° C. The temperature was maintained for 12 hours and then increased over a period of 5 hours and 40 minutes to 800° C. The temperature was then maintained for 3 hours. Linear cooling to 25° C. was then carried out under a stream of air of 50 standard l/h. The resulting dried starting composition had a loss on ignition of 11% by weight under the calcination conditions.

The calcined starting composition A1 displayed, as a function of the dispersing pressure applied in each case, the particle size distributions shown in FIGS. 2a and 2b (⋄=1.2 bar abs.; □=2.0 bar abs.; Δ=4.5 bar abs.).

The calcined starting composition A1 obtained in this way was milled in an impact plate mill model REF L18 (from Pallmann Maschinenfabrik GmbH & Co KG, 66482 Zweibrucken, Germany) at 3700 rpm (mill settings: rotor diameter=175 mm; tip velocity=34 m/s).

The calcined and milled starting composition A1 displayed, as a function of the dispersing pressure applied in each case, the particle size distributions shown in FIGS. 3a and 3b (⋄=1.2 bar abs.; □=2.0 bar abs.; Δ=4.5 bar abs.).

The resulting dₓ values are shown in Table 1 below in comparison with the uncalcined and calcined starting composition A1.

TABLE 1

| | Dispersing | | | |
|---|---|---|---|---|
| | pressure | d₁₀ | d₅₀ | d₉₀ |
| | [bar abs.] | [μm] | [μm] | [μm] |
| Uncalcined A1 | 1.2 | 1.225 | 6.954 | 13.831 |
| | 2.0 | 0.664 | 2.857 | 7.871 |
| | 4.5 | 0.664 | 1.560 | 3.352 |
| Calcined A1 | 1.2 | 225.160 | 710.905 | 1400.054 |
| | 2.0 | 2.531 | 617.082 | 1348.022 |
| | 4.5 | 0.874 | 1.537 | 2.643 |
| Calcined and | 1.2 | 0.922 | 1.728 | 3.200 |
| milled A1 | | | | |
| | 2.0 | 1.016 | 1.778 | 3.055 |
| | 4.5 | 0.799 | 1.322 | 2.122 |

The calcined and milled starting composition A1 displayed, as a function of the duration of the ultrasonic pretreatment (USP), the particle size distributions in suspension shown in FIGS. 3a and 3b (⋄=0 min USP; □=1=1 min USP; Δ=3 min USP).

The resulting dₓ values are shown in Table 2 below.

TABLE 2

| Duration of | d₁₀ | d₅₀ | d₉₀ |
|---|---|---|---|
| ultrasonic treatment | [μm] | [μm] | [μm] |
| 0 min | 1.165 | 3.589 | 115.669 |
| 1 min | 1.019 | 3.128 | 86.667 |
| 3 min | 0.894 | 2.714 | 6.826 |

The phase composition of the calcined finely divided starting composition A1 was determined by means of X-ray diffraction on an Advance D8 series 2 having a multiple sample changer (from Bruker AXS GmbH, 76187 Karlsruhe, Germany). FIG. 4 shows the XRD pattern of the milled calcined starting composition A1. The abscissa shows the diffraction angle on the 2θ scale (2 theta scale) and the ordinate shows the absolute intensity of the X-radiation. The phases present there were 43% of monoclinic WO₃ and 57% of orthorhombic Bi₂W₂O₉.

### b) Preparation of a Finely Divided Starting Composition A2 (Mo₁₂Co_{5.5}Fe_{3.0}Si_{1.61}K_{0.08})

The preparation of the finely divided starting compositions A2 was carried out as described in DE 10 2008 042 064 A1.

### c) Production of an Annular all-Active Shaped Catalyst Precursor Body ES (Under an N₂ Atmosphere)

The finely divided starting composition A1 to which Sipernat® D17 had been added was homogeneously mixed in a ratio of 1:1 with the finely divided starting composition A2 (total amount: 580 g comprising 0.39 g of Sipernat) in an Amixon mixer (model VMT 1, specially manufactured for BASF SE, from Amixon GmbH, 33106 Paderborn, Germany; fill volume: 1 l, power: 0.7 kW) using a clockwise-rotating insert with 2 blades (speed of rotation: 111 rpm) for 15 minutes. Based on the total composition present, 1% by weight of finely divided graphite of the type TIMREX T44 (from Timcal Ltd., 6743 Bodlo, Switzerland; cf. WO 2008/087116 and DE 10 2011 084 040 A1) was homogeneously mixed into this in a drum hoop mixer (hoop diameter: 740 mm, drum volume: 4.5 l) (speed of rotation: 48 rpm, mixing time: 30 min). In a laboratory calendar having 2 contrarotating steel rollers (roller diameter: 10 cm; roller length utilized for intermediate compaction: 13.5 cm; speed of rotation of rollers: 10 rpm), the respective resulting homogeneous mixture was compacted at a pressing pressure of 9 bar and subsequently pressed through a sieve having square mesh openings having a width of 0.8 mm. A further 2.5% by weight of the same finely divided graphite were mixed into the respective, coarsened, as described, spray-dried powder, based on its weight, in the above-described drum hoop mixer (48 rpm, 30 minutes mixing time). The resulting finely divided intimate dry mixture was subsequently, as described in DE-A 10200804093 and DE 10 2011 084 040 A1, densified (tableted) by means of a Kilian rotary tableting machine (9-fold tableting machine) model S100 (from Kilian, D-50735 Cologne) under a nitrogen atmosphere and at an ambient temperature of 25° C. to give annular all-active shaped catalyst precursor bodies having the geometry A×H×I=5 mm×3 mm×2 mm, a lateral compressive strength in the range from 19 N to 30 N and a mass of 129 mg. The pressing force was from 3.0 to 3.5 kN and the fill height was from 7.5 to 9 mm.

### d) Thermal Pretreatment and Calcination of the Annular all-Active Shaped Catalyst Precursor Body ES

For the final thermal treatment, 1000 g in each case of the all-active shaped catalyst precursor bodies produced in each case were uniformly distributed over 4 adjacent meshes having a square base area of in each case 150 mm×150 mm (bed height: 50-100 mm) and placed in a convection shaft oven (from Nabertherm; oven model S60/65A, 28865 Lilienthal, Germany) through which 1200 standard l/h of predried air (which had an entry temperature of 140° C.) was passed (the convection oven was located in an environment having a temperature of 25° C.). A detailed description of the installation of the thermocouples is given in DE 10 2011 084 040 A1. While maintaining the air flow (including its entry temperature), the temperature in the convection shaft oven was subsequently varied as follows, with the temperature increases occurring essentially linearly over time. Over a period of 72 minutes, the temperature was increased from 25° C. to 130° C. The temperature was maintained for 72 minutes and then increased over a period of 36 minutes to 190° C. The 190° C. were maintained for 72 minutes, and the temperature was then increased over a period of 36 minutes to 220° C. The 220° C. were maintained for 72 minutes, and the temperature was then increased over a period of 36 minutes to 265° C. The 265° C. were maintained for 72 minutes, and the temperature was then increased over a period of 93 minutes to 380° C. The 380° C. were maintained for 187 minutes, and the temperature was then increased over a period of 93 minutes to 430° C. The 430° C. were maintained for 187 minutes, and the temperature was then increased over a period of 93 minutes to the final temperature of 456° C. This was maintained for 467 minutes. The oven was then cooled over a period of 24 hours to 25° C. For this purpose, both the heating for the convection shaft oven and also the heating of the air stream were switched off (the air flow of 1200 standard l/h as such was maintained; the entry temperature of the air stream was then 25° C.).

The loss on ignition under the calcination conditions was 26% by weight.

The specific BET surface area (determined by gas adsorption (N₂) by the Brunnerauer-Emmet-Teller (BET) method) of the resulting annular all-active catalyst body was 14 m²/g. A description of the BET method of determination may be found in DIN ISO 9277 and in J. Am. Chem. Soc. vol. 60, No. 2, pages 309-319 (1938).

FIG. 5 shows the XRD pattern of the calcined all-active shaped catalyst precursor body ES. The abscissa shows the diffraction angle on the 20 scale (2 theta scale) and the ordinate shows the absolute intensity of the X-radiation.

### Comparative Example 2

Example 1 step a) was repeated, but with the bismuth nitrate solution being brought to a pH of 1.0 and this pH being kept constant during the addition of the tungstic acid slurry. The molar Bi/W ratio was 1.74:1.

### Comparative Example 3

Example 1 step a) was repeated, but with the bismuth nitrate solution being brought to a pH of 4.0 and this pH being kept constant during the addition of the tungstic acid slurry. The molar Bi/W ratio was 0.89:1.

Comparative examples 2 and 3 show that a pH of from 1.5 to 3 is critical in order to achieve stoichiometric precipitation (Bi/W ratio of 2:1).

### Reference Example 4

### Production of Annular Comparative all-Active Shaped Catalyst Bodies VS which are not According to the Invention and have the Following Stoichiometry of the Active Composition

[Bi₁W₂O_{7.5}]ₐ[Mo₁₂Co_{5.5}Fe_{3.0}Si_{1.6}K_{0.08}Oₓ]₁

### a) Preparation of the Finely Divided Starting Compositions B1 (Bi₁W₂O_{7.5}=½ Bi₂W₂O₉*1WO₃)

The preparation of the finely divided starting composition B1 which was not according to the invention was carried out as described in example 1 “Preparation of a starting composition 1” in DE 10 2008 042 064 A1.

### b) Preparation of a Finely Divided Starting Composition A2 (Mo₁₂Co_{5.5}Fe₃Si_{1.6}K_{0.08})

The preparation of the finely divided starting composition B2 which was not according to the invention was carried out as described in example 1 “Preparation of a starting composition 2” in DE 10 2008 042 064 A1.)

### Production of an Annular all-Active Shaped Catalyst Precursor Body VS (Under an N₂ Atmosphere)

The production of the all-active shaped catalyst precursor body VS was carried out as described under I) for the all-active shaped catalyst body VS.

### d) Thermal Pretreatment and Calcination of the Annular all-Active Shaped Catalyst Precursor Body VS

The production of the all-active shaped catalyst precursor body VS was carried out as described under I) for the all-active shaped catalyst body VS.

The loss on ignition under the calcination conditions was 26% by weight.

The specific BET surface area (determined by gas adsorption (N₂) by the Brunnerauer-Emmet-Teller (BET) method) of the annular all-active catalyst body obtained was 14 m²/g.

FIG. 6 shows the XRD pattern of the calcined all-active shaped catalyst precursor body VS. The abscissa shows the diffraction angle on the 20 scale (2 theta scale) and the ordinate shows the absolute intensity of the X-radiation.

### I) Testing of the Annular all-Active Shaped Catalyst Bodies for the Heterogeneous Partial Oxidation of Propene to Acrolein

A reaction tube (V2A steel; 21.3 mm external diameter, 3.2 mm wall thickness, 14.9 mm internal diameter, length 125 cm) was charged from the top downward in the flow direction as follows:

Section 1: about 25 cm long

40 g of steatite balls (C220 Steatite from CeramTec, 73207 Plochingen, Germany), having a diameter of from 2 to 3 mm as preliminary bed.

Section 2: about 70 cm long

Catalyst charge comprising 40 g of the respective annular all-active shaped catalyst body diluted with 80 g of steatite balls (C220 Steatite from CeramTec, 73207 Plochingen, Germany) having a diameter of from 2 to 3 mm.

Temperature control of the reaction tube was effected by means of a salt melt (mixture of 53% by weight of potassium nitrate, 40% by weight of sodium nitrite and 7% by weight of sodium nitrate) which was electrically heated from the outside and through which nitrogen was bubbled.

The reactor was continuously supplied with a feed gas mixture (mixture of air, polymer grade propylene and nitrogen) having the composition:
5% by volume of propene,
9.5% by volume of oxygen and
N₂ as balance to 100% by volume,
   where the throughput of the feed gas mixture through the reaction tube was 100 standard l/h (5 standard l/h of propene) and the salt bath temperature T_{SB} was a constant 380° C.

Table 3 below shows the results obtained as a function of the all-active shaped catalyst body used after 70 hours of operation in each case, where S_{DP} is the selectivity to the desired product and S_{COx} is the selectivity to CON.

TABLE 3

| All-active shaped catalyst | T_{SB} | Conv. | S_{DP} | S_{COx} |
|---|---|---|---|---|
| body | [° C.] | [%] | [mol %] | [mol %] |
| ES | 380 | 97.3 | 85.5 | 13.4 |
| VS | 380 | 97.4 | 85.9 | 13.4 |

The results shown in the table demonstrate that, when the starting composition A1 is prepared according to the invention, the all-active shaped catalyst body displays a comparable conversion at the same salt bath temperature.

The COₓ selectivity is likewise comparable to that of the comparative catalyst VS which is not according to the invention. The desired product selectivity is similar to that of the comparative catalyst VS.

1: A process for producing a shaped catalyst body comprising a multi-element oxide formula I as an active composition,
[Bi₁W_{b}Oₓ]ₐ[Mo₁₂Z¹_{c}Z²_{d}FeₑZ³_{f}Z⁴_{g}Z⁵ₕO_{y}]₁ (I),
wherein
Z¹ is at least one element selected from the group consisting of nickel and cobalt,
Z² is at least one element selected from the group consisting of alkali metals and alkaline earth metals,
Z³ is at least one element selected from the group consisting of zinc, phosphorus, arsenic, boron, antimony, tin, cerium, vanadium, chromium and bismuth,
Z⁴ is at least one element selected from the group consisting of silicon, aluminum, titanium, tungsten and zirconium,
Z⁵ is at least one element from the group consisting of copper, silver, gold, yttrium, lanthanum and the lanthanides,
a=0.1 to 3,
b=0.1 to 10,
c=1 to 10,
d=0.01 to 2,
e=0.01 to 5,
f=0 to 5,
g=0 to 10,
h=0 to 1, and
x and y represent numbers which are determined by the valence and abundance of the elements other than oxygen in formula I,
wherein the process comprises:
preforming a mixed oxide Bi₁W_{b}Oₓ, wherein the preformation of the mixed oxide Bi₁W_{b}Oₓ comprises coprecipitation from an aqueous environment at a pH in the range from 1.5 to 3 to obtain a precipitate; and
isolating the precipitate by a mechanical separation process.

2: The process according to claim 1, wherein an aqueous preparation of a bismuth source having a pH of from 1.5 to 3 is initially charged, an aqueous preparation of a tungsten source is added and the pH of the mixture is maintained in the range from 1.5 to 3 during the addition of the tungsten source.

3: The process according to claim 2, wherein a tungsten source is tungstic acid and/or tungsten oxide and the pH of the mixture is maintained in the range from 1.5 to 3 during the addition of the tungsten source by addition of a base.

4: The process according to claim 3, wherein the base is an aqueous solution of an alkali metal hydroxide.

5: The process according to claim 1, wherein the mechanical separation process is selected from the group consisting of filtration, centrifugation, sedimentation and floatation.

6: The process according to claim 1, wherein the precipitate is washed salt-free with a washing liquid.

7: The process according to claim 6, wherein the washing liquid is deionized water.

8: The process according to claim 6, wherein the electrical conductivity of the used washing liquid is determined.

9: The process according to claim 1, wherein the preformed mixed oxide Bi₁W_{b}Oₓ has a particle diameter d₅₀ of from 2.8 to 3.6 μm.

10: The process according to claim 1,
wherein
the preformed mixed oxide Bi₁W_{b}Oₓ is mixed with a precursor having the stoichiometry [Mo₁₂Z¹_{c}Z²_{d}FeₑZ³_{f}Z⁴_{g}Z⁵ₕO_{y}],
the mixture is shaped to form a shaped body, and
the shaped body is thermally treated and calcined at elevated temperature to obtain the shaped catalyst body.
